(19) United States
(12) Patent Application Publication
(10) Pub. No.: US 2014/0087235 A1
(43) Pub. Date: Mar. 27, 2014

(54) NONAQUEOUS-SECONDARY-BATTERY LAYERED STRUCTURE AND NONAQUEOUS-SECONDARY-BATTERY LAYERING METHOD

(71) Applicants: Hiroshi Kajitani, Tokyo (JP); Kentaro Nakahara, Tokyo (JP); Takanori Nishi, Tokyo (JP); Shigeyuki Iwasa, Tokyo (JP); Hiroshi Kato, Tokyo (JP); Yoichi Shimizu, Tokyo (JP); Haruyuki Yoshigahara, Tokyo (JP)

(72) Inventors: Hiroshi Kajitani, Tokyo (JP); Kentaro Nakahara, Tokyo (JP); Takanori Nishi, Tokyo (JP); Shigeyuki Iwasa, Tokyo (JP); Hiroshi Kato, Tokyo (JP); Yoichi Shimizu, Tokyo (JP); Haruyuki Yoshigahara, Tokyo (JP)

(21) Appl. No.: 14/116,331

(22) PCT Filed: May 10, 2012
(86) PCT No.: PCT/JP2012/062567

§ 371 Date: Nov. 7, 2013

(30) Foreign Application Priority Data
May 11, 2011 (JP) 2011-105894

(51) Int. Cl. H01M 4/64; H01M 2/14

(52) U.S. Cl. CPC H01M 4/64; H01M 2/14
USPC 429/149

(57) ABSTRACT

A layered structure includes a configuration in which non-aqueous secondary batteries are layered. Each non-aqueous secondary battery includes: a positive-electrode collector layer; a positive-electrode layer formed on one surface of the positive-electrode collector layer; a negative-electrode collector layer; a negative-electrode layer formed on one surface of the negative-electrode collector layer so as to be opposed to the positive-electrode layer; a separator containing an electrolytic solution provided between the positive-electrode layer and the negative-electrode layer; a positive-electrode-side insulating layer formed on another surface of the positive-electrode collector layer; and a negative-electrode-side insulating layer formed on another surface of the negative-electrode collector layer. Two non-aqueous secondary batteries share one negative-electrode-side insulating layer.

### TECHNICAL FIELD

This invention relates to a thin non-aqueous secondary battery layered structure which has high stability, can be multi-layered easily, and can be reduced in entire thickness, and a layering method therefor.

### BACKGROUND ART

As a power source to be used in various mobile devices such as a mobile telephone and a notebook personal computer, a lithium ion secondary battery which is a high energy density non-aqueous secondary battery has been used. The lithium ion secondary battery mainly has a cylindrical shape or a rectangular shape, and in most cases, is fainted by inserting a wound electrode laminate into a metallic can. Depending on the kind of mobile device, the thickness of the battery is requested to be thin. However, the metallic can formed by deep drawing processing is difficult to have a thickness of 3 mm or less, and hence it is difficult to set the thickness of a secondary battery using a metallic can to 3 mm or less.

On the other hand, in recent years, various types of IC cards and non-contact IC cards have been spread, and most of the non-contact IC cards are designed in such a manner that electric power is generated by an electromagnetic induction coil, and an electric circuit is operated only during use. In order to provide these IC cards with a display function or a sensing function so as to greatly enhance the security and convenience, it is desired that a secondary battery serving as an energy source be built in each IC card. The size of each IC card is standardized to, for example, 85 mm×48 mm×0.76 mm, and hence the thickness of a secondary battery to be built in the IC card is required to be 0.76 mm or less. Further, even in various card-type devices which do not comply with the specification, it is preferred that the thickness of a secondary battery be 2.5 mm or less. Therefore, it is difficult to use the above-mentioned secondary battery using a metallic can.

As a thin non-aqueous secondary battery having a thickness of 2.5 mm or less, there is given a non-aqueous secondary battery including an aluminum laminate film on an exterior body. The aluminum laminate film includes mainly a thermoplastic resin layer, an aluminum foil layer, and an insulating layer, and has a feature of being able to be molded and processed easily while having a sufficient gas barrier property. However, in the case of the thin non-aqueous secondary battery, the proportion of the exterior body occupying the thickness of the entire battery is high, and hence a technology for making the exterior body as thin as possible is required in order to enhance energy density.

Patent Literature 1 discloses an aluminum laminate film with a 7-layer structure including an innermost layer, a first adhesive layer, a first surface treatment layer, an aluminum foil layer, a second surface treatment layer, a second adhesive layer, and an outermost layer, and having excellent moldability, gas bather property, heat sealing property, and electrolytic solution resistance (Patent Literature 1).

Patent Literature 2 proposes a thin battery which does not require an aluminum laminate by allowing a positive-electrode collector and a negative-electrode collector to serve as an exterior body. In this battery, peripheral edges of the positive-electrode collector and the negative-electrode collector are joined with a sealing agent containing polyolefin or engineering plastic (Patent Literature 2).

Patent Literature 3 also proposes a thin battery which does not require an aluminum laminate by allowing a positive-electrode collector and a negative-electrode collector to serve as an exterior body. This literature proposes that peripheral edges of the positive-electrode collector and the negative-electrode collector are joined with an olefin-based hot melt resin, a urethane-based reaction-type hot melt resin, an ethylene vinyl alcohol based hot melt resin, a polyamide-based hot melt resin, or the like, and these hot melt resins are filled with an inorganic filler (Patent Literature 3).

Further, Patent Literature 4 discloses a structure of an electric double-layer capacitor in which an electrolyte is sandwiched between a positive-electrode collector containing aluminum and a negative-electrode collector similarly containing aluminum, and a gap is filled with a multilayer structure comprising a welded layer and a gas barrier layer (Patent Literature 4). That is, Patent Literature 4 discloses an electric double-layer capacitor in which the positive-electrode collector and the negative-electrode collector are formed of the same aluminum.

### CITATION LIST

### Patent Literature

Patent Literature 1: Japanese Unexamined Patent Application Publication (JP-A) No. 2007-073402
Patent Literature 2: Japanese Unexamined Patent Application Publication (JP-A) No. Hei 09-077960
Patent Literature 3: Japanese Unexamined Patent Application Publication (JP-A) No. 2003-059486
Patent Literature 4: Japanese Unexamined Patent Application Publication (JP-A) No. 2005-191288

### DISCLOSURE OF THE INVENTION

### Problem to be Solved by the Invention

Here, in the case of considering a capacity increase in a configuration in which a positive-electrode collector and a negative-electrode collector also serve as an exterior body, it is necessary to perform layering when there is a limit to an area.

In this case, if layering is performed directly, the adhering thickness between batteries and the thickness of a base part of the exterior body at a joining part become problems.

However, the inventions described in the above-mentioned literatures have a problem in that none of them has a configuration considering the reduction in thickness when performing layering.

Further, in the inventions described in the above-mentioned literatures, there may be a problem in handling of a separator during assembling of a battery.

Specifically, the separator is made of, for example, a very thin polyolefin-based porous film, and the separator with such a configuration is likely to contract and to be charged with static electricity. Therefore, it is difficult for the separator to adhere to a positive-electrode layer and a negative-electrode layer and to be positioned correctly in the adhesion.

This invention has been made in view of the foregoing reasons, and it is an object of this invention to provide a secondary battery layered structure which can be multi-layered easily and which is easy to produce.

### Means to Solve the Problem

In order to achieve the above-mentioned object, according to a first aspect of this invention, there is provided a non-aqueous secondary battery layered structure comprising a configuration in which a plurality of non-aqueous secondary batteries are layered, the plurality of non-aqueous secondary batteries each including: a positive-electrode collector layer; a positive-electrode layer formed on one surface of the positive-electrode collector layer; a negative-electrode collector layer; a negative-electrode layer foamed on one surface of the negative-electrode collector layer so as to be opposed to the positive-electrode layer; a separator containing an electrolytic solution provided between the positive-electrode layer and the negative-electrode layer; a positive-electrode-side insulating layer formed on another surface of the positive-electrode collector layer; a negative-electrode-side insulating layer foimed on another surface of the negative-electrode collector layer; and a sealing agent comprising a multilayer structure including at least a positive-electrode fusion layer, a gas barrier layer, and a negative-electrode fusion layer, the sealing agent being provided on an inner surface of a peripheral edge of the positive-electrode collector layer and an inner surface of a peripheral edge of the negative-electrode collector layer so as to surround the positive-electrode layer and the negative-electrode layer, in which adjacent ones of the plurality of non-aqueous secondary batteries share the positive-electrode-side insulating layer and/or the negative-electrode-side insulating layer.

According to a second aspect of this invention, there is provided a non-aqueous secondary battery layering method, including layering a plurality of non-aqueous secondary batteries so that adjacent ones of the plurality of non-aqueous secondary batteries share a positive-electrode-side insulating layer and/or a negative-electrode-side insulating layer, the plurality of non-aqueous secondary batteries each including: a positive-electrode collector layer; a positive-electrode layer formed on one surface of the positive-electrode collector layer; a negative-electrode collector layer; a negative-electrode layer formed on one surface of the negative-electrode collector layer so as to be opposed to the positive-electrode layer; a separator containing an electrolytic solution provided between the positive-electrode layer and the negative-electrode layer; a positive-electrode-side insulating layer formed on another surface of the positive-electrode collector layer; a negative-electrode-side insulating layer foimed on another surface of the negative-electrode collector layer; and a sealing agent comprising a multilayer structure including at least a positive-electrode fusion layer, a gas barrier layer, and a negative-electrode fusion layer, the sealing agent being provided on an inner surface of a peripheral edge of the positive-electrode collector layer and an inner surface of a peripheral edge of the negative-electrode collector layer so as to surround the positive-electrode layer and the negative-electrode layer.

### Effect of the Invention

According to this invention, the secondary battery layered structure which can be multi-layered easily and which is easy to produce can be provided.

Further, according to this invention, even in the case where a capacity is increased by performing layering, the same production method as that for one layer is used, and the entire battery can be reduced in thickness. Therefore, battery mounting with high reliability is realized, and further, an operation time of an application using this battery can be extended. Further, the sealing agent and the separator are integrally formed, and hence mounting becomes easy and the battery can be provided at low cost.

### BRIEF DESCRIPTION OF THE DRAWING

FIG. 1 is a sectional view of a layered structure 200 according to a first embodiment of this invention.

FIG. 2 is a sectional view illustrating a configuration of a non-aqueous secondary battery 100 forming the layered structure 200.

FIG. 3 is a sectional view illustrating a layered structure 201 in the case where the non-aqueous secondary batteries 100 are simply layered.

FIG. 4 is a sectional view of a layered structure 200a according to a second embodiment of this invention.

FIG. 5 is an enlarged view of the vicinity of a negative-electrode-side insulating layer 10a of FIG. 4.

FIG. 6 is a sectional view of a layered structure 200b according to a third embodiment of this invention.

FIG. 7 is an enlarged view of the vicinity of the negative-electrode-side insulating layer 10a of FIG. 6.

FIG. 8 is a sectional view of a layered structure 200c according to a fourth embodiment of this invention.

FIG. 9 is an enlarged view of the vicinity of a separator 3 of FIG. 8.

### BEST MODE FOR EMBODYING THE INVENTION

Preferred embodiments of this invention are described hereinafter in detail with reference to the drawings.

### [Configuration]

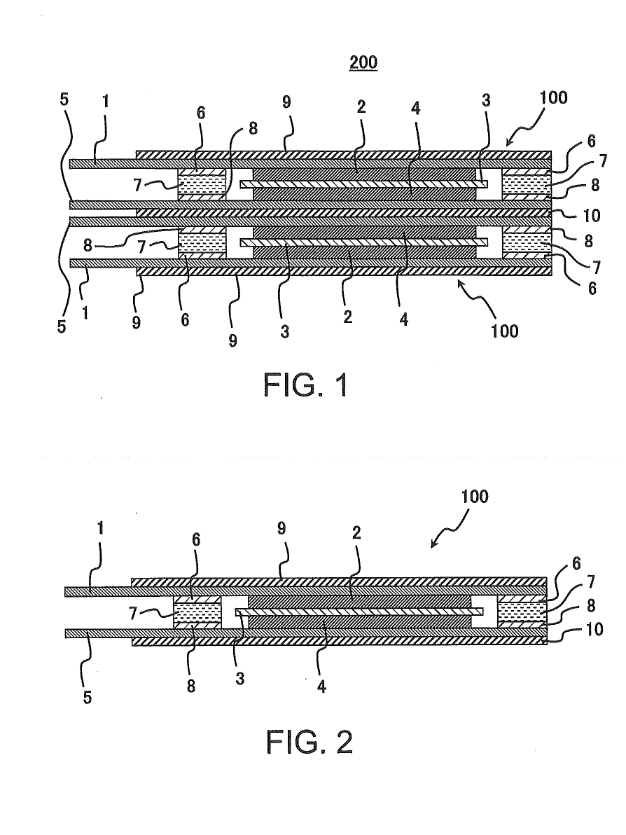

First, referring to FIGS. 1 and 2, an outline of a configuration of a layered structure 200 (non-aqueous secondary battery layered structure) according to a first embodiment of this invention is described.

As illustrated in FIG. 1, the layered structure 200 comprises a configuration in which non-aqueous secondary batteries 100 are layered.

FIG. 1 exemplifies a case where two non-aqueous secondary batteries 100 are layered.

As illustrated in FIG. 2, each non-aqueous secondary battery 100 includes a positive-electrode collector layer 1, a positive-electrode layer 2 formed on one surface of the positive-electrode collector layer 1, a negative-electrode collector layer 5, a negative-electrode layer 4 formed on one surface of the negative-electrode collector layer 5 so as to be opposed to the positive-electrode layer 2, a separator 3 that contains an electrolytic solution and is provided between the positive-electrode layer 2 and the negative-electrode layer 4, a positive-electrode-side insulating layer 9 formed on the other surface of the positive-electrode collector layer 1, a negative-electrode-side insulating layer 10 formed on the other surface of the negative-electrode collector layer 5, and a sealing agent comprising a multilayer structure including at least a positive-electrode fusion layer 6, a gas barrier layer 7, and a negative-electrode fusion layer 8, the sealing agent being provided on an inner surface of a peripheral edge of the positive-electrode collector layer 1 and an inner surface of a peripheral edge of the negative-electrode collector layer 5 so as to surround the positive electrode layer 2 and the negative electrode layer 4.

In this case, as illustrated in FIG. 2, (adjacent) two non-aqueous secondary batteries 100 share one negative-electrode-side insulating layer 10, and the negative-electrode collector layers 5 (and the negative-electrode layers 4) are opposed to each other with the negative-electrode-side insulating layer 10 interposed therebetween.

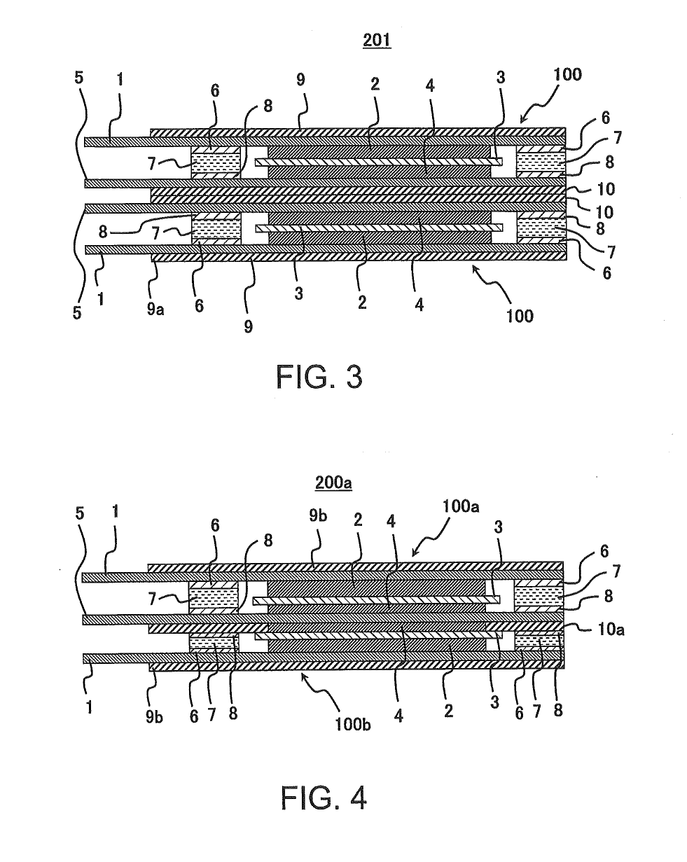

Thus, the insulating layer is shared by the two adjacent non-aqueous secondary batteries, and hence, the layered structure 200 can be reduced in thickness by the thickness of the shared insulating layer, compared to the case of a layered structure 201 in which the non-aqueous secondary batteries 100 are simply layered as illustrated in FIG. 3.

That is, there are four insulating layers (two positive-electrode-side insulating layers 9 and two negative-electrode-side insulating layers 10) in FIG. 3, whereas there are three insulating layers (two positive-electrode-side insulating layers 9 and one negative-electrode-side insulating layer 10) in FIG. 1, with the result that the layered structure 200 is reduced in thickness by one negative-electrode-side insulating layer 10.

The outline of the configuration of the layered structure 200 is as described above.

Next, each constituent member of the non-aqueous secondary battery 100 is described in more detail.

The positive-electrode layer 2 contains an active material. As the active material contained in the positive-electrode layer 2, for example, lithium manganate such as LiMn₂O₄, which is an oxide comprising a spinel structure, can be used. However, the active material is not necessarily limited thereto, and for example, LiNi_{0.5}Mn_{1.5}O₄, which is also an oxide comprising a spinel structure, LiFePO₄, LiMnPO₄, and Li₂CoPO₄F, which are oxides comprising an olivine structure, LiCoO₂, LiNi_{1-x-y}CoₓAl_{y}O₂, and LiNi_{0.5-x}Mn_{0.5-x}Co₂ₓO₂, which are oxides comprising a layered rock-salt structure, solid solutions of these oxides comprising a layered rock-salt structure and Li₂MnO₃, sulfur, a nitroxyl radical polymer, and the like can also be used.

Further, a plurality of kinds of those positive-electrode active materials may be used in combination. In particular, a nitroxyl radical polymer is a flexible positive-electrode active material, unlike other oxides, and hence is preferred as a positive-electrode active material for a flexible thin non-aqueous secondary battery to be built in an IC card.

The content of an active material in the positive electrode is, for example, 90 wt %, but can be adjusted arbitrarily. When the content of the active material is 10 wt % or more with respect to the total weight of the positive electrode, a sufficient capacity is obtained. Further, in the case where it is desired to obtain a largest possible capacity, it is preferred that the content of the active material be 50 wt % or more, in particular, 80 wt % or more.

In order to impart conductivity to the positive-electrode layer 2, the positive-electrode layer 2 contains a conductivity-imparting agent. As the conductivity-imparting agent, for example, graphite powder having an average particle diameter of 6 μm and acetylene black can be used, but a conventionally known conductivity-imparting agent material may be used. As the conventionally known conductivity-imparting agent, for example, there may be given carbon black, furnace black, a vapor grown carbon fiber, carbon nanotube, carbon nanohorn, metal powder, and a conductive polymer.

In order to bind the above-mentioned materials, the positive-electrode layer 2 contains a binder. As the binder, for example, polyvinylidene fluoride can be used, and conventionally known binders may be used. Examples of the conventionally known binders include polytetrafluoroethylene, a vinylidene fluoride-hexafluoropropylene copolymer, a styrene-butadiene copolymer rubber, polypropylene, polyethylene, polyacrylonitrile, and an acrylic resin.

As described later, the positive-electrode layer 2 can be produced, for example, by dispersing the above-mentioned materials in a solvent to prepare a positive-electrode ink, printing and applying the positive-electrode ink to the positive-electrode collector layer, and removing a dispersion solvent by heat-drying. As the dispersion solvent of the positive-electrode ink, conventionally known solvents, specifically, N-methylpyrrolidone (NMP), water, tetrahydrofuran, and the like can be used.

The negative-electrode layer 4 contains an active material. As the negative-electrode active material contained in the negative-electrode layer 4, graphite such as a mesocarbon microbead (hereinafter referred to as “MCMB”) can be used. However, the negative-electrode active material is not necessarily limited thereto. For example, graphite can also be replaced by a conventionally known negative-electrode active material. As the conventionally known negative-electrode active materials, for example, there are given carbon materials such as activated carbon and hard carbon, a lithium metal, a lithium alloy, lithium ion occluding carbon, and other various kinds of simple metals and alloys.

In order to impart conductivity to the negative-electrode layer 4, the negative-electrode layer 4 contains a conductivity-imparting agent. As the conductivity-imparting agent, for example, a conductivity-imparting agent containing acetylene black as a main component can be used, but a conventionally known conductivity-imparting agent may be used. As the conventionally known conductivity-imparting agent, for example, there may be given carbon black, acetylene black, graphite, furnace black, a vapor grown carbon fiber, carbon nanotube, carbon nanohorn, metal powder, and a conductive polymer.

In order to bind the above-mentioned materials, the negative-electrode layer 4 contains a binder. As the binder, for example, polyvinylidene fluoride can be used, and conventionally known binders may be used. Examples of the conventionally known binders include polytetrafluoroethylene, a vinylidene fluoride-hexafluoropropylene copolymer, a styrene-butadiene copolymer rubber, polypropylene, polyethylene, polyacrylonitrile, and an acrylic resin.

As described later, the negative-electrode layer 4 can be produced, for example, by dispersing the above-mentioned materials in a solvent to prepare a negative-electrode ink, printing and applying the negative-electrode ink to the negative-electrode collector layer, and removing a dispersion solvent by heat-drying. As the dispersion solvent of the negative-electrode ink, conventionally known solvents, for example, NMP, water, tetrahydrofuran, and the like can be used.

The separator 3 in this invention is interposed between the positive-electrode layer 2 and the negative-electrode layer 4, and serves to conduct only ions without conducting electrons by containing the electrolytic solution. No particular limitation is imposed on a material for the separator 3 in this invention, and conventionally known materials can be used. As specific materials, there are given a polyolefin such as polypropylene and polyethylene, a porous film such as a fluorine resin, a non-woven fabric, and a glass filter.

The electrolytic solution carries and transports charge between the positive-electrode layer 2 and the negative-electrode layer 4, and in general, those which have ion conductivity of 10⁻⁵ to 10⁻¹ S/cm at room temperature are used. As the electrolytic solution, for example, a mixed solvent of ethylene carbonate (EC) and diethyl carbonate (DEC) containing 1.0 M lithium hexafluorophosphate (LiPF₆) as a supporting electrolyte (mixed volume ratio of EC/DEC=3/7) is used, and conventionally known electrolytic solutions may be used. As the conventionally known electrolytic solutions, there may be used, for example, an electrolytic solution obtained by dissolving an electrolyte salt in a solvent. Examples of such solvent include: organic solvents such as ethylene carbonate, propylene carbonate, dimethyl carbonate, diethyl carbonate, methyl ethyl carbonate, γ-butyrolactone, tetrahydrofuran, dioxolane, sulfolane, dimethylformamide, dimethylacetamide, and N-methyl-2-pyrrolidone; and a sulfuric acid aqueous solution, and water. In this invention, those solvents may be used alone or two or more kinds thereof may be used in combination. In addition, examples of the electrolyte salt include lithium salts such as LiPF₆, LiClO₄, LiBF₄, LiCF₃SO₃, LiN(CF₃SO₂)₂, LiN(C₂F₅SO₂)₂, LiC(CF₃SO₂)₃, and LiC(C₂F₅SO₂)₃. In addition, the concentration of the electrolyte salt is not particularly limited to 1.0 M.

It is desired that the positive-electrode collector layer 1 be formed of a material containing aluminum as a main component, for example, an aluminum foil. However, the material for the positive-electrode collector layer 1 is not particularly limited to aluminum, and conventionally known materials can be used. Specific examples for the material include nickel, copper, gold, silver, titanium, and an aluminum alloy. The thickness of the positive-electrode collector layer 1 is, for example, about 40 μm, and is not necessarily limited thereto. Note that, the thickness is preferably 12 μm or more, more preferably 30 μm or more from the viewpoint of permeability of gas. The thickness is preferably 100 μm or less, more preferably 68 μm or less from the viewpoint of energy density.

It is desired that the negative-electrode collector layer 5 be formed of a material containing copper as a main component, for example, a copper foil. However, the material for the negative-electrode collector layer 5 is not particularly limited to copper, and conventionally known materials can be used. Specific examples for the material include nickel, aluminum, gold, silver, titanium, and an aluminum alloy. The thickness of the negative-electrode collector layer 5 is, for example, about 18 μm, and is not necessarily limited thereto. Note that, the thickness is preferably 8 μm or more, more preferably 15 μm or more from the viewpoint of permeability of gas. The thickness is preferably 50 μm or less, more preferably 30 μm or less from the viewpoint of energy density.

The sealing agent serves to prevent water vapor of ambient air or the like from coming into contact with power-generation elements (positive-electrode layer 2, negative-electrode layer 4, separator 3, etc.) of the thin non-aqueous secondary battery, and comprises the multilayer structure including at least the positive-electrode fusion layer 6, the gas barrier layer 7, and the negative-electrode fusion layer 8. The sealing agent may comprise a multilayer structure of 4 or more layers by using an adhesive layer between the respective layers or using a plurality of fusion layers or gas barrier layers 7. The case where respective layers are stacked separately to be integrated or the case where a sealing agent with a multilayer structure is prepared in advance and inserted between the positive-electrode collector layer 1 and the negative-electrode collector layer 5 are considered. The same effects can be expected as a result, as long as a sealing agent with a multilayer structure including at least the positive-electrode fusion layer 6, the gas barrier layer 7, and the negative electrode fusion layer 8 is used. However, from the viewpoint of processability, it is preferred that a three-layer film of modified polyolefin resin/liquid crystal polyester/modified polyolefin or a three-layer film of ionomer resin/liquid crystal polyester resin/ionomer resin be interposed to be used between the positive-electrode collector layer 1 and the negative-electrode collector layer 5.

Note that, the modified polyolefin resin refers to a resin obtained, for example, by graft-modifying polyethylene or polypropylene with a polar group such as maleic anhydride, acrylic acid, or glycidylmethacrylic acid, and the ionomer resin refers to a resin comprising a special structure, for example, in which molecules of an ethylene-methacrylic acid copolymer or an ethylene-acrylic acid copolymer are bonded with metal ions of sodium, zinc, or the like.

The gas barrier layer 7 serves to prevent the permeation of water vapor gas from an outside to the inside of the battery, and prevent short-circuit between the positive-electrode collector layer 1 and the negative-electrode collector layer 5. Although no particular limitation is imposed on the material for the gas barrier layer 7, a liquid crystal polyester resin is preferred because it is excellent in a gas barrier property and insulation, and has flexibility and bending resistance.

The term “liquid crystal polyester resin” is a collective term including a liquid crystal polymer (thermotropic liquid crystal polymer) such as a thermotropic liquid crystal polyester or a liquid crystal polyester amide (thermotropic liquid crystal polyester amide), which is synthesized from monomers such as an aromatic dicarboxylic acid, an aromatic diol, and an aromatic hydroxycarboxylic acid as main monomers. Typical examples of the liquid crystal polyester resin include: type I (following formula 1) synthesized from parahydroxybenzoic acid (PHB), terephthalic acid, and 4,4′-biphenol; type II (following formula 2) synthesized from PHB and 2,6-hydroxynaphthoic acid; and type III (following formula 3) synthesized from PHB, terephthalic acid, and ethylene glycol. As the liquid crystal polyester resin in this invention, any of the type I to type III may be used. However, from the viewpoint of heat resistance, size stability, and water vapor barrier property, it is preferred that the liquid crystal polyester resin be wholly aromatic liquid crystal polyester (type I and type II) or wholly aromatic liquid crystal polyester airside. Further, the liquid crystal polyester resin in this invention also includes a polymer blend with another component containing a liquid crystal polyester resin at a ratio of 60 wt % or more, and a mixed composition with an inorganic filler or the like.

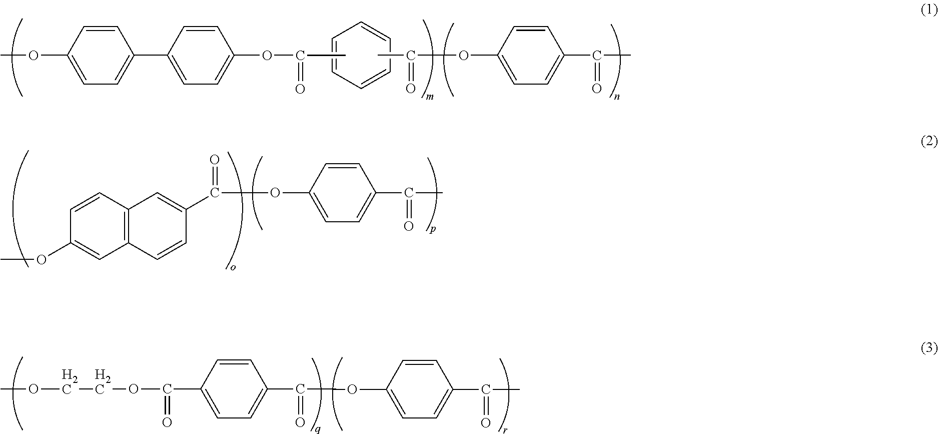

Although the form of the gas barrier layer 7 is not particularly limited, it is preferred that the gas barrier layer 7 be a film which is easy to be processed. The film in this invention is a concept including a sheet, a plate, and a foil (in particular, regarding a constituent material for a metal layer). In order to obtain such a base, a conventionally known production method in accordance with a resin forming the base can be used. Further, as a film using the above-mentioned liquid crystal polyester resin which is particularly preferred in this invention, for example, there is given “BIAC-CB (trade name)” manufactured by Japan Gore-Tex Inc. No particular limitation is imposed on the thickness of the gas barrier layer 7 in this invention. However, when the gas barrier layer 7 is too thin, there arises a problem of an insulating property, and when the gas barrier layer 7 is too thick, there arises a problem in a gas barrier property. Thus, the thickness of the gas barrier layer 7 is, for example, 1 μm or more and 700 μm or less, preferably 5 μm or more and 200 μm or less, more preferably 10 μm or more and 100 μm or less, most preferably 10 μm or more and 60 μm or less.

The positive-electrode fusion layer 6 and the negative-electrode fusion layer 8 serve to fuse the gas barrier layer 7 to the positive-electrode collector layer 1 and fuse the gas barrier layer 7 to the negative-electrode collector layer 5. Although no particular limitation is imposed on materials for the positive-electrode fusion layer 6 and the negative-electrode fusion layer 8, for example, there are given a modified polyolefin resin, an ionomer resin, and the like. These resins may be used alone or in combination of several kinds for the positive-electrode fusion layer 6 and the negative-electrode fusion layer 8 in this invention. The resins to be used in the positive-electrode fusion layer 6 and the negative-electrode fusion layer 8 have a gas barrier property inferior to that of the resin used in the gas barrier layer 7, but have an excellent heat sealing property. Thus, by using the resins to be used in the positive-electrode fusion layer 6 and the negative-electrode fusion layer 8 simultaneously with the resin for the gas barrier layer 7, both an excellent gas barrier property and a heat sealing property can be satisfied.

The positive-electrode-side insulating layer 9 and the negative-electrode-side insulating layer 10 prevent short-circuit during an operation, and for example, a liquid crystal polymer resin (LCP) such as a liquid crystal polyester resin is used for these layers.

### [Production Method]

Next, referring to FIG. 1, an example of a production method for the layered structure 200 according to a first embodiment of this invention is described.

### <Production of Positive-Electrode Layer>

The positive-electrode layer 2 containing 90 wt % of lithium manganate comprising a spinel structure, 5 wt % of graphite powder having an average particle diameter of 6 μm, 2 wt % of acetylene black, and 3 wt % of polyvinylidene fluoride (hereinafter referred to as “PVDF”) was produced on an aluminum foil (positive-electrode collector layer 1) having a thickness of 40 μm, a rear surface of the aluminum foil having attached thereto a liquid crystal polyester (positive-electrode-side insulating layer 9) having a thickness of 50 μm.

### <Production of Negative-Electrode Layer>

The negative-electrode layer 4 containing 88 wt % of mesocarbon microbeads (hereinafter referred to as “MCMB”) manufactured by Osaka Gas, Co., Ltd. graphitized at 2,800° C., 2 wt % of acetylene black, and 10 wt % of PVDF was produced on a copper foil (negative-electrode collector layer 5) having a thickness of 18 a rear surface of the copper foil having attached thereto a liquid crystal polyester (negative-electrode-side insulating layer 10) having a thickness of 50 μm.

### <Production of Secondary Battery>

The positive-electrode layer 2 and the negative-electrode layer 4 produced by the above-mentioned methods were opposed to each other with the separator 3 that contains an electrolytic solution interposed between the electrodes and with a film obtained by molding the sealing agent including three layers of “modified polyolefin resin/liquid crystal polyester resin/modified polyolefin resin (positive-electrode fusion layer 6/gas barrier layer 7/negative-electrode fusion layer 8)” into a frame-like shape (peripheral edge shape with a center portion punched out) interposed between the peripheral edges of the electrode layers. The composition of the electrolytic solution was a mixed solvent (mixed volume ratio of EC/DEC=3/7) of ethylene carbonate (hereinafter referred to as “EC”) and diethyl carbonate (hereinafter referred to as “DEC”) containing 1.0 M of LiPF₆ as a supporting electrolyte.

Next, another non-aqueous secondary battery 100 was further produced on the negative-electrode-side insulating layer 10 by the above-mentioned method (so that the negative-electrode-side insulating layer 10 was shared by the two non-aqueous secondary batteries 100).

The layered structure 200 was produced in the foregoing procedure.

Thus, according to the first embodiment, the layered structure 200 comprises a configuration in which the non-aqueous secondary batteries 100 are layered, in which the two non-aqueous secondary batteries 100 share one negative-electrode-side insulating layer 10, and the negative-electrode collector layers 5 are opposed to each other with one negative-electrode-side insulating layer 10 interposed therebetween.

Therefore, compared to the case where the non-aqueous secondary batteries 100 are simply layered, the layered structure 200 can be reduced in thickness by the shared insulating layer.

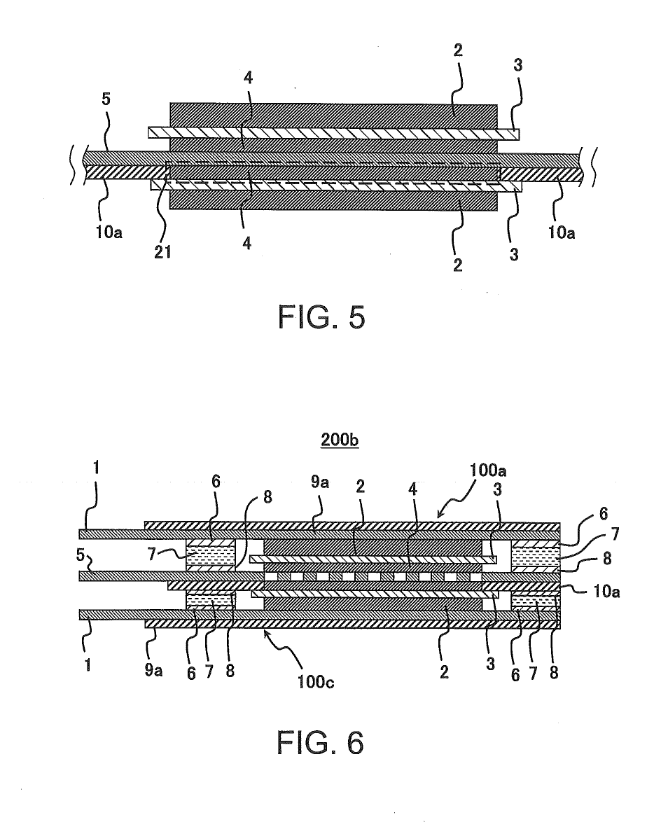

Next, a second embodiment of this invention is described with reference to FIGS. 4 and 5.

The second embodiment comprises a configuration in which an opening 21 is provided in a negative-electrode-side insulating layer 10a, and the negative-electrode layer 4 of one non-aqueous secondary battery 100b is buried in the opening 21 in the first embodiment.

Note that, in the second embodiment, elements having functions similar to those of the first embodiment are denoted with the same reference numerals as those therein, and the descriptions thereof are omitted.

As illustrated in FIG. 4, a layered structure 200a according to the second embodiment comprises a configuration in which non-aqueous secondary batteries 100a, 100b are layered, and the non-aqueous secondary batteries 100a, 100b share the negative-electrode-side insulating layer 10a.

On the other hand, as illustrated in FIG. 5, a portion of the negative-electrode-side insulating layer 10a opposed to the negative-electrode layer 4 is opened to form the opening 21, and the negative-electrode layer 4 of the non-aqueous secondary battery 100b is buried in the opening 21.

Therefore, the negative-electrode layer 4 of the non-aqueous secondary battery 100a and the negative electrode layer 4 of the non-aqueous secondary battery 100b are both in contact with one negative-electrode collector layer 5.

That is, the non-aqueous secondary batteries 100a, 100b share not only the negative-electrode-side insulating layer 10 but also the negative-electrode collector layer 5.

With such a configuration, the layered structure 200a can be further reduced in thickness.

Specifically, the layered structure 200a comprises the negative-electrode-side insulating layer 10a and the negative-electrode collector layer 5, the respective numbers of which are smaller by one compared to the case where the non-aqueous secondary batteries 100 are simply layered as illustrated in FIG. 3, and one negative-electrode layer 4 is buried in the opening 21. Therefore, the layered structure 200a can be reduced in thickness by one negative-electrode-side insulating layer 10a, one negative-electrode collector layer 5, and one negative-electrode layer 4.

Note that, the opening 21 is obtained, for example, by forming the negative-electrode collector layer 5 on one surface of the negative-electrode-side insulating layer 10a, and thereafter etching a portion of the negative-electrode-side insulating layer 10a opposed to the negative-electrode layer 4.

Further, in the layered structure 200a, the negative-electrode layers 4 are formed on both surfaces of the negative-electrode collector layer 5 by applying a negative-electrode active material to a portion of the negative-electrode collector layer 5 exposed from the opening 2, and further applying a negative-electrode active material to a surface on an opposite side of the negative-electrode collector layer 5.

Thus, according to the second embodiment, the layered structure 200a comprises a configuration in which the non-aqueous secondary batteries 100a, 100b are layered, and the two non-aqueous secondary batteries 100a share one negative-electrode-side insulating layer 10a.

Accordingly, the second embodiment exhibits the same effects as those of the first embodiment.

Further, according to the second embodiment, a portion of the negative-electrode-side insulating layer 10a opposed to the negative-electrode layer 4 is opened to form the opening 21. The negative-electrode layer 4 of the non-aqueous secondary battery 100b is buried in the opening 21, and the negative-electrode layer 4 of the non-aqueous secondary battery 100a and the negative-electrode layer 4 of the non-aqueous secondary battery 100b are both in contact with one negative-electrode collector layer 5.

Therefore, the non-aqueous secondary batteries 100a, 100b share not only the negative-electrode-side insulating layer 10a but also the negative-electrode collector layer 5, and hence can be further reduced in thickness compared to the first embodiment.

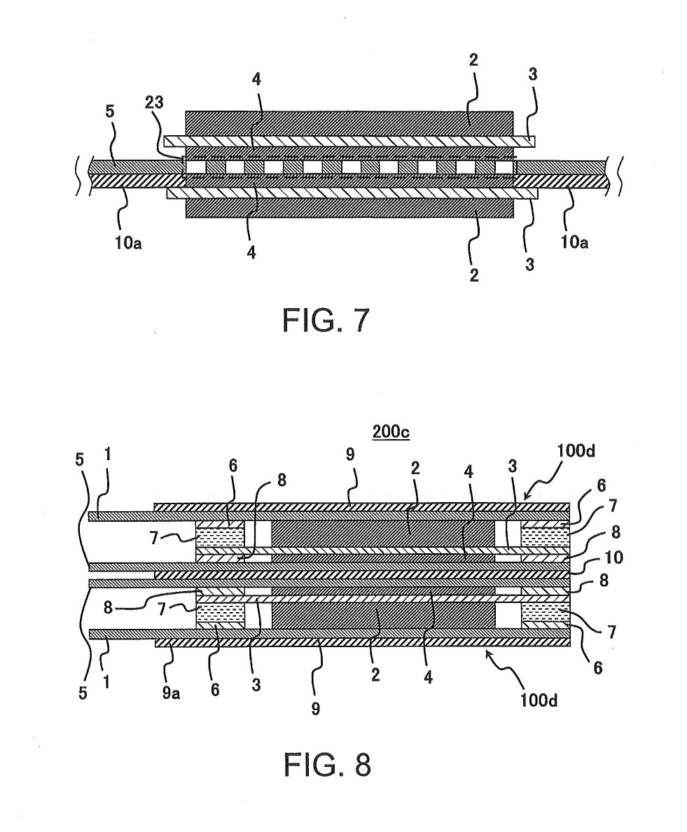

Next, a third embodiment of this invention is described with reference to FIGS. 6 and 7.

The third embodiment comprises a configuration in which through-holes are provided in part of a contact surface of the negative-electrode collector layer 5 with respect to the negative-electrode layer 4 to form a mesh part 23 in the second embodiment.

Note that, in the third embodiment, elements having functions similar to those of the second embodiment are denoted with the same reference numerals as those therein, and the descriptions thereof are omitted.

As illustrated in FIG. 6, a layered structure 200b according to the third embodiment comprises a configuration in which non-aqueous secondary batteries 100a, 100c are layered, and through-holes are provided in part of the contact surface of the negative-electrode collector layer 5 with respect to the negative-electrode layer 4 to form the mesh part 23 as illustrated in FIG. 7.

Note that, when the negative-electrode layer 4 is to be formed on the negative-electrode collector layer 5, a negative-electrode active material may be applied to only one surface of the mesh part 23. Then, the negative-electrode active material flows also to the other surface of the negative-electrode collector layer 5 through openings of the mesh part 23, and hence the negative-electrode layer 4 is also formed on the other surface of the negative-electrode collector layer 5.

That is, owing to the presence of the mesh part 23, the negative-electrode layer 4 can be foamed on both surfaces of the negative-electrode collector layer 5 merely by applying a negative-electrode active material to one surface of the mesh part 23, with the result that production cost can be reduced.

Note that, in the case where the mesh part 23 is formed, it is desired that a negative-electrode active material contain lithium.

In this way, according to the third embodiment, a portion of the negative-electrode-side insulating layer 10a in contact with the negative-electrode layer 4 is penetrated to foim the opening 21. The negative-electrode layer 4 of the non-aqueous secondary battery 100c is buried in the opening 21, and the negative-electrode layer 4 of the non-aqueous secondary battery 100a and the negative-electrode layer 4 of the non-aqueous secondary battery 100c are both in contact with one negative-electrode collector layer 5.

Accordingly, the third embodiment exhibits the same effects as those of the second embodiment.

Further, according to the third embodiment, part of the portion of the negative-electrode collector layer 5, which is in contact with the negative-electrode layer 4, is opened to form the mesh part 23.

Therefore, the negative-electrode layer 4 can be formed on both surfaces of the negative-electrode collector layer 5 merely by applying a negative-electrode active material to one surface of the mesh part 23, with the result that production cost can be reduced compared to that of the second embodiment.

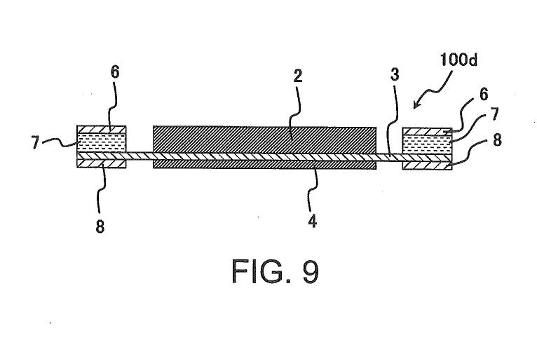

Next, a fourth embodiment of this invention is described with reference to FIGS. 8 and 9.

The fourth embodiment comprises a configuration in which the separator 3 is interposed in the sealing agent in the first embodiment.

Note that, in the fourth embodiment, elements having functions similar to those of the first embodiment are denoted with the same reference numerals as those therein, and the descriptions thereof are omitted.

As illustrated in FIG. 8, a layered structure 200c according to the fourth embodiment comprises a configuration in which non-aqueous secondary batteries 100d are layered, in which the non-aqueous secondary batteries 100d share one negative-electrode-side insulating layer 10, and the negative-electrode collector layers 5 are opposed to each other with the negative-electrode-side insulating layer 10 interposed therebetween.

On the other hand, as illustrated in FIG. 9, the separator 3 is interposed in the sealing agent in the non-aqueous secondary battery 100d.

Specifically, in FIG. 9, the separator 3 is interposed between the gas barrier layer 7 and the negative-electrode fusion layer 8.

Thus, by interposing the separator 3 in the sealing agent, handling of the separator (adhesion, positioning, etc. of the separator 3 with respect to the positive-electrode layer 2 and the negative-electrode layer 4) becomes easy, which makes it easy to assemble the non-aqueous secondary battery 100d. Further, owing to the ease of handling of the separator 3, the production speed of the non-aqueous secondary battery 100d and the layered structure 200c can be increased.

Note that, the thickness of the positive-electrode layer 2 is generally larger than that of the negative-electrode layer 4, as illustrated in FIG. 9. Therefore, it is preferred that the separator be mounted between the gas barrier layer 7 and the negative-electrode fusion layer 8, rather than between the positive-electrode fusion layer 6 and the gas barrier layer 7, because the concentration of stress with respect to the separator 3 is suppressed, and a battery with long-term reliability can be produced with this configuration.

Thus, according to the fourth embodiment, the layered structure 200c comprises a configuration in which the non-aqueous secondary batteries 100d are layered, in which the two non-aqueous secondary batteries 100d share one negative-electrode-side insulating layer 10, and the negative-electrode collector layers 5 are opposed to each other with the negative-electrode-side insulating layer 10 interposed therebetween.

Accordingly, the fourth embodiment exhibits the same effects as those of the first embodiment.

Further, according to the fourth embodiment, the separator 3 is interposed in the sealing agent in the non-aqueous secondary battery 100d.

Therefore, handling of the separator becomes easy, and the non-aqueous secondary battery 100d can be produced easily, with the result that the production speed of the layered structure 200c can be increased.

### EXAMPLES

Next, production methods according to the embodiments are described by way of specific examples.

The non-aqueous secondary battery 100 forming the layered structure 200 according to this invention was produced under the following conditions.

### Example 1

90 wt % of lithium manganate comprising a spinel structure, 5 wt % of graphite powder having an average particle diameter of 6 nm and 2 wt % of acetylene black as conductivity-imparting agents, and 3 wt % of PVDF as a binder were weighed, and dispersed and mixed in N-methylpyrrolidone (hereinafter referred to as “NMP”) to obtain a positive-electrode ink. The positive-electrode ink produced by the above-mentioned method was printed and applied to an aluminum foil having a thickness of 40 μm by screen printing, a rear surface of the aluminum foil having attached thereto a liquid crystal polyester having a thickness of 50 μm, and NMP, which was a dispersion solvent, was removed by heat-drying. After that, the resultant was subjected to compression molding with a roller press machine, and thus a positive electrode including the liquid crystal polyester and the aluminum foil and having a total thickness of 140 μm was produced.

As a negative-electrode active material, MCMB manufactured by Osaka Gas, Co., Ltd. graphitized at 2,800° C. was used. 88 wt % of MCMB, 2 wt % of acetylene black as a conductivity-imparting agent, and 10 wt % of PVDF as a binder were weighed, and dispersed and mixed in NMP to obtain a negative-electrode ink. The negative-electrode ink produced by the above-mentioned method was printed and applied to a copper foil having a thickness of 18 μm by screen printing, a rear surface of the copper foil having attached thereto a liquid crystal polyester having a thickness of 50 μm, and NMP, which was a dispersion solvent, was removed by heat-drying. After that, the resultant was subjected to compression molding with a roller press machine, and thus a negative electrode including the liquid crystal polyester and the copper foil and having a total thickness of 100 μm was produced.

The positive electrode and the negative electrode produced by the above-mentioned methods were opposed to each other with a porous film separator interposed therebetween. In this case, a film obtained by molding a sealing agent including three layers of “maleic anhydride-modified polypropylene/liquid crystal polyester/maleic anhydride-modified polypropylene” each having a thickness of 50 μm into a frame-like shape was interposed between the peripheral edges of the electrode layers. Three sides of the obtained rectangular laminate were fused by heating at a heater temperature of 190° C., and 60 μL of an electrolytic solution were injected through the remaining one open side. The composition of the electrolytic solution was a mixed solvent of EC and DEC (mixed volume ratio of EC/DEC=3/7) containing 1.0 M of LiPF₆ as a supporting electrolyte. The entire cell was reduced in pressure so as to impregnate a gap well with the electrolytic solution. After that, the remaining one side was fused by heating under reduced pressure to obtain a thin secondary battery.

### Example 2

90 wt % of cobalt, aluminum-substituted lithium nickelate (LiNi_{0.80}Co_{0.15}Al_{0.05}O₂) comprising a layered rock-salt structure, 5 wt % of graphite powder and 2 wt % of acetylene black as conductivity-imparting agents, and 3 wt % of PVDF as a binder were weighed, and dispersed and mixed in N-methylpyrrolidone (hereinafter referred to as “NMP”) to obtain a positive-electrode ink. The positive-electrode ink produced by the above-mentioned method was printed and applied to an aluminum foil having a thickness of 40 μm by screen printing, a rear surface of the aluminum foil having attached thereto a liquid crystal polyester having a thickness of 50 μm, and NMP, which was a dispersion solvent, was removed by heat-drying. After that, the resultant was subjected to compression molding with a roller press machine, and thus a positive electrode including the liquid crystal polyester and the aluminum foil and having a total thickness of 140 μm was produced.

As a negative-electrode active material, MCMB manufactured by Osaka Gas, Co., Ltd. graphitized at 2,800° C. was used. 88 wt % of MCMB, 2 wt % of acetylene black as a conductivity-imparting agent, and 10 wt % of PVDF as a binder were weighed, and dispersed and mixed in NMP to obtain a negative-electrode ink. The negative-electrode ink produced by the above-mentioned method was printed and applied to a copper foil having a thickness of 18 μm by screen printing, a rear surface of the copper foil having attached thereto a liquid crystal polyester having a thickness of 50 μm, and NMP, which was a dispersion solvent, was removed by heat-drying. After that, the resultant was subjected to compression molding with a roller press machine, and thus a negative electrode including the liquid crystal polyester and the copper foil and having a total thickness of 120 μm was produced.

The positive electrode and the negative electrode produced by the above-mentioned methods were opposed to each other with a porous film separator interposed therebetween. In this case, a film obtained by molding a sealing agent including three layers of “maleic anhydride-modified polyethylene/liquid crystal polyester/maleic anhydride-modified polyethylene” each having a thickness of 75 μm into a frame-like shape was interposed between the peripheral edges of the electrode layers. Three sides of the obtained rectangular laminate were fused by heating at a heater temperature of 150° C., and 60 μL of an electrolytic solution were injected through the remaining one open side. The composition of the electrolytic solution was a mixed solvent of EC and DEC (mixed volume ratio of EC/DEC=3/7) containing 1.0 M of LiPF₆ as a supporting electrolyte. The entire cell was reduced in pressure so as to impregnate a gap well with the electrolytic solution. After that, the remaining one side was fused by heating under reduced pressure to obtain a thin secondary battery.

### Example 3

70% of an organic radical polymer, poly(2,2,6,6-tetramethylpiperidinyloxy-4-yl methacrylate), 14% of vapor grown carbon fiber, 7% of acetylene black, 8% of carboxymethyl cellulose, and 1% of Teflon (trademark) were weighed, and dispersed and mixed in water to obtain a positive-electrode ink. The positive-electrode ink produced by the above-mentioned method was printed and applied to an aluminum foil having a thickness of 40 μm by screen printing, a rear surface of the aluminum foil having attached thereto a liquid crystal polyester having a thickness of 50 μm, and water, which was a dispersion solvent, was removed by heat-drying. After that, the resultant was subjected to compression molding with a roller press machine, and thus a positive electrode including the liquid crystal polyester and the aluminum foil and having a total thickness of 170 μm was produced.

As a negative-electrode active material, MCMB manufactured by Osaka Gas, Co., Ltd. graphitized at 2,800° C. was used. 88 wt % of MCMB, 2 wt % of acetylene black as a conductivity-imparting agent, and 10 wt % of PVDF as a binder were weighed, and dispersed and mixed in NMP to obtain a negative-electrode ink. The negative-electrode ink produced by the above-mentioned method was printed and applied to a copper foil having a thickness of 18 μm by screen printing, a rear surface of the copper foil having attached thereto a liquid crystal polyester having a thickness of 50 μm, and NMP, which was a dispersion solvent, was removed by heat-drying. After that, the resultant was subjected to compression molding with a roller press machine, and thus a negative electrode including the liquid crystal polyester and the copper foil and having a total thickness of 100 μm was produced.

The positive electrode and the negative electrode produced by the above-mentioned methods were opposed to each other with a porous film separator interposed therebetween. In this case, a film obtained by molding a sealing agent including three layers of “glycidyl methacrylate-modified polyethylene/liquid crystal polyester/glycidyl methacrylate-modified polyethylene” each having a thickness of 100 μm into a frame-like shape was interposed between the peripheral edges of the electrode layers. Three sides of the obtained rectangular laminate were fused by heating at a heater temperature of 150° C., and 60 μL of an electrolytic solution were injected through the remaining one open side. The composition of the electrolytic solution was a mixed solvent of EC and DEC (mixed volume ratio of EC/DEC=3/7) containing 1.0 M of LiPF₆ as a supporting electrolyte. The entire cell was reduced in pressure so as to impregnate a gap well with the electrolytic solution. After that, the remaining one side was fused by heating under reduced pressure to obtain a thin secondary battery.

### Comparative Examples

Next, as Comparative Examples, non-aqueous secondary batteries were produced under different conditions from those of Examples 1 to 3.

### Comparative Example 1

90 wt % of lithium manganate comprising a spinel structure, 5 wt % of graphite powder having an average particle diameter of 6 μm and 2 wt % of acetylene black as conductivity-imparting agents, and 3 wt % of PVDF as a binder were weighed, and dispersed and mixed in N-methylpyrrolidone (hereinafter referred to as “NMP”) to obtain a positive-electrode ink. The positive-electrode ink produced by the above-mentioned method was printed and applied to an aluminum foil having a thickness of 40 μm by screen printing, a rear surface of the aluminum foil having attached thereto a liquid crystal polyester having a thickness of 50 μm, and NMP, which was a dispersion solvent, was removed by heat-drying. After that, the resultant was subjected to compression molding with a roller press machine, and thus a positive electrode including the liquid crystal polyester and the aluminum foil and having a total thickness of 140 μm was produced.

As a negative-electrode active material, MCMB manufactured by Osaka Gas, Co., Ltd. graphitized at 2,800° C. was used. 88 wt % of MCMB, 2 wt % of acetylene black as a conductivity-imparting agent, and 10 wt % of PVDF as a binder were weighed, and dispersed and mixed in NMP to obtain a negative-electrode ink. The negative-electrode ink produced by the above-mentioned method was printed and applied to a copper foil having a thickness of 18 μm by screen printing, a rear surface of the copper foil having attached thereto a liquid crystal polyester having a thickness of 50 μm, and NMP, which was a dispersion solvent, was removed by heat-drying. After that, the resultant was subjected to compression molding with a roller press machine, and thus a negative electrode including the liquid crystal polyester and the copper foil and having a total thickness of 100 μm was produced.

The positive electrode and the negative electrode produced by the above-mentioned methods were opposed to each other with a porous film separator interposed therebetween. In this case, a film obtained by molding a sealing agent including a maleic anhydride-modified polyethylene having a thickness of 50 μm into a frame-like shape was interposed between the peripheral edges of the electrode layers. Three sides of the obtained rectangular laminate were fused by heating at a heater temperature of 150° C., and 60 μL of an electrolytic solution were injected through the remaining one open side. The composition of the electrolytic solution was a mixed solvent of EC and DEC (mixed volume ratio of EC/DEC=3/7) containing 1.0 M of LiPF₆ as a supporting electrolyte. The entire cell was reduced in pressure so as to impregnate a gap well with the electrolytic solution. After that, the remaining one side was fused by heating under reduced pressure to obtain a thin secondary battery.

### Comparative Example 2

90 wt % of lithium manganate comprising a spinel structure, 5 wt % of graphite powder having an average particle diameter of 6 μm and 2 wt % of acetylene black as conductivity-imparting agents, and 3 wt % of PVDF as a binder were weighed, and dispersed and mixed in N-methylpyrrolidone (hereinafter referred to as “NMP”) to obtain a positive-electrode ink. The positive-electrode ink produced by the above-mentioned method was printed and applied to an aluminum foil having a thickness of 40 μm by screen printing, a rear surface of the aluminum foil having attached thereto a liquid crystal polyester having a thickness of 50 μm, and NMP, which was a dispersion solvent, was removed by heat-drying. After that, the resultant was subjected to compression molding with a roller press machine, and thus a positive electrode including the liquid crystal polyester and the aluminum foil and having a total thickness of 140 μm was produced.

As a negative-electrode active material, MCMB manufactured by Osaka Gas, Co., Ltd. graphitized at 2,800° C. was used. 88 wt % of MCMB, 2 wt % of acetylene black as a conductivity-imparting agent, and 10 wt % of PVDF as a binder were weighed, and dispersed and mixed in NMP to obtain a negative-electrode ink. The negative-electrode ink produced by the above-mentioned method was printed and applied to a copper foil having a thickness of 18 μm by screen printing, a rear surface of the copper foil having attached thereto a liquid crystal polyester having a thickness of 50 μm, and NMP, which was a dispersion solvent, was removed by heat-drying. After that, the resultant was subjected to compression molding with a roller press machine, and thus a negative electrode including the liquid crystal polyester and the copper foil and having a total thickness of 100 μm was produced.

The positive electrode and the negative electrode produced by the above-mentioned methods were opposed to each other with a porous film separator interposed therebetween. In this case, a film obtained by molding a sealing agent including a liquid crystal polyester having a thickness of 50 μm into a frame-like shape was interposed between the peripheral edges of the electrode layers. An attempt was made to fuse three sides of the obtained rectangular laminate by heating at a heater temperature of 190° C. However, the three sides were not able to be fused satisfactorily due to the excessively high melting point of the liquid crystal polyester.

### Comparative Example 3

90 wt % of lithium manganate comprising a spinel structure, 5 wt % of graphite powder having an average particle diameter of 6 μm and 2 wt % of acetylene black as conductivity-imparting agents, and 3 wt % of PVDF as a binder were weighed, and dispersed and mixed in N-methylpyrrolidone (hereinafter referred to as “NMP”) to obtain a positive-electrode ink. The positive-electrode ink produced by the above-mentioned method was printed and applied to an aluminum foil having a thickness of 10 μm by screen printing, a rear surface of the aluminum foil having attached thereto a liquid crystal polyester having a thickness of 50 μm, and NMP, which was a dispersion solvent, was removed by heat-drying. After that, the resultant was subjected to compression molding with a roller press machine, and thus a positive electrode including the liquid crystal polyester and the aluminum foil and having a total thickness of 140 μm was produced.

As a negative-electrode active material, MCMB manufactured by Osaka Gas, Co., Ltd. graphitized at 2,800° C. was used. 88 wt % of MCMB, 2 wt % of acetylene black as a conductivity-imparting agent, and 10 wt % of PVDF as a binder were weighed, and dispersed and mixed in NMP to obtain a negative-electrode ink. The negative-electrode ink produced by the above-mentioned method was printed and applied to a copper foil having a thickness of 18 μm by screen printing, a rear surface of the copper foil having attached thereto a liquid crystal polyester having a thickness of 50 μm, and NMP, which was a dispersion solvent, was removed by heat-drying. After that, the resultant was subjected to compression molding with a roller press machine, and thus a negative electrode including the liquid crystal polyester and the copper foil and having a total thickness of 100 μm was produced.

The positive electrode and the negative electrode produced by the above-mentioned methods were opposed to each other with a porous film separator interposed therebetween. In this case, a film obtained by molding a sealing agent including three layers of “glycidyl methacrylate-modified polyethylene/liquid crystal polyester/glycidyl methacrylate-modified polyethylene” each having a thickness of 50 μm into a frame-like shape was interposed between the peripheral edges of the electrode layers. Three sides of the obtained rectangular laminate were fused by heating at a heater temperature of 150° C., and 60 μL of an electrolytic solution were injected through the remaining one open side. The composition of the electrolytic solution was a mixed solvent of EC and DEC (mixed volume ratio of EC/DEC=3/7) containing 1.0 M of LiPF₆ as a supporting electrolyte. The entire cell was reduced in pressure so as to impregnate a gap well with the electrolytic solution. After that, the remaining one side was fused by heating under reduced pressure to obtain a thin secondary battery.

### Comparative Example 4

90 wt % of lithium manganate comprising a spinel structure, 5 wt % of graphite powder having an average particle diameter of 6 μm and 2 wt % of acetylene black as conductivity-imparting agents, and 3 wt % of PVDF as a binder were weighed, and dispersed and mixed in N-methylpyrrolidone (hereinafter referred to as “NMP”) to obtain a positive-electrode ink. The positive-electrode ink produced by the above-mentioned method was printed and applied to an aluminum foil having a thickness of 70 μm by screen printing, a rear surface of the aluminum foil having attached thereto a liquid crystal polyester having a thickness of 50 μm, and NMP, which was a dispersion solvent, was removed by heat-drying. After that, the resultant was subjected to compression molding with a roller press machine, and thus a positive electrode including the liquid crystal polyester and the aluminum foil and having a total thickness of 140 μm was produced.

As a negative-electrode active material, MCMB manufactured by Osaka Gas, Co., Ltd. graphitized at 2,800° C. was used. 88 wt % of MCMB, 2 wt % of acetylene black as a conductivity-imparting agent, and 10 wt % of PVDF as a binder were weighed, and dispersed and mixed in NMP to obtain a negative-electrode ink. The negative-electrode ink produced by the above-mentioned method was printed and applied to a copper foil having a thickness of 18 μm by screen printing, a rear surface of the copper foil having attached thereto a liquid crystal polyester having a thickness of 50 μm, and NMP, which was a dispersion solvent, was removed by heat-drying. After that, the resultant was subjected to compression molding with a roller press machine, and thus a negative electrode including the liquid crystal polyester and the copper foil and having a total thickness of 100 μm was produced.

The positive electrode and the negative electrode produced by the above-mentioned methods were opposed to each other with a porous film separator interposed therebetween. In this case, a film obtained by molding a sealing agent including three layers of “maleic anhydride-modified polypropylene/liquid crystal polyester/maleic anhydride-modified polypropylene” each having a thickness of 100 μm into a frame-like shape was interposed between the peripheral edges of the electrode layers. Three sides of the obtained rectangular laminate were fused by heating at a heater temperature of 190° C., and 60 μL of an electrolytic solution were injected through the remaining one open side. The composition of the electrolytic solution was a mixed solvent of EC and DEC (mixed volume ratio of EC/DEC=3/7) containing 1.0 M of LiPF₆ as a supporting electrolyte. The entire cell was reduced in pressure so as to impregnate a gap well with the electrolytic solution. After that, the remaining one side was fused by heating under reduced pressure to obtain a thin secondary battery.

### <Evaluation of Cell>

In the procedure of Comparative Example 2, a cell was not able to be produced as described above. Therefore, the cells produced in Examples 1 to 3 and Comparative Examples 1, 3, and 4 were put in a thermostat chamber at 20° C., and initial charge and discharge were conducted at a rate of 0.1 C. As a result, it was found that the capacity was not obtained in the cell produced in Comparative Example 1, and short-circuit occurred between the positive and negative electrodes. After that, charge and discharge were repeated at a rate of 1 C in the cells produced in Examples 1 to 3 and Comparative Examples 3 and 4. As a result, it was found that the degradation in capacity was conspicuous only in the cell of Comparative Example 3. The stability, number of short-circuits, and calculated energy density of each cell are summarized in Table 1.

Note that, regarding the calculated energy density in Table 1, assuming that the calculated energy density of Example 1 is 1.0, the case where the calculated energy density is 0.5 or more is indicated by “∘”, the case where the calculated energy density is 0.2 to 0.3 is indicated by “Δ”, and the case where the calculated energy density is 0.2 or less is indicated by “x”.

TABLE 1

| Specific | | Number of | Calculated energy |
|---|---|---|---|
| Example | Stability | short-circuits | density |
| Example | ∘ | 0/5 | ∘ |
| Example | ∘ | 0/3 | ∘ |
| Example | ∘ | 0/3 | ∘ |
| Comparative | — | 2/2 | ∘ |
| Example | | | |
| Comparative | x | — | ∘ |
| Example | | | |
| Comparative | Δ | 0/2 | ∘ |
| Example | | | |
| Comparative | ∘ | 0/2 | Δ |
| Example | | | |

### INDUSTRIAL APPLICABILITY

The non-aqueous electrolyte secondary battery according to this invention can satisfy the high adhesiveness with both electrode collectors, the high short-circuit prevention reliability, and the sufficient gas barrier property simultaneously although being a thin battery not using an aluminum laminate film exterior body. Therefore, the non-aqueous electrolyte secondary battery can be used widely as a thin non-aqueous electrolyte secondary battery which is easy to use. Examples of the applications of this invention include an IC card, an RFID tag, various sensors, and mobile telephone equipment.

Note that, this invention is not limited to the above-mentioned embodiments and examples.

Needless to say, those skilled in the art understand that this invention can be variously modified or improved within the scope of this invention and those modified or improved examples are also included in this invention.

For example, in the embodiments, the layered structure is disclosed in which the negative-electrode-side insulating layer 10 or the negative-electrode collector layer 5 is shared. However, a configuration in which the positive-electrode-side insulating layer 9 or the positive-electrode collector layer 1 is shared may be used.

This application claims priority based on Japanese Patent Application No. 2011-105894 filed on May 11, 2011, the disclosure of which is incorporated herein by reference in its entirety.

### DESCRIPTION OF SYMBOLS

1 positive-electrode collector layer
2 positive-electrode layer
3 separator
4 negative-electrode layer
5 negative-electrode collector layer
6 positive-electrode fusion layer
7 gas barrier layer
8 negative-electrode fusion layer
9 positive-electrode-side insulating layer
10 negative-electrode-side insulating layer
10a negative-electrode-side insulating layer
21 opening
23 mesh part
100 non-aqueous secondary battery
100a non-aqueous secondary battery
100b non-aqueous secondary battery
100d non-aqueous secondary battery
200 layered structure
201 layered structure
200a layered structure
200b layered structure
200c layered structure

1. A non-aqueous secondary battery layered structure, comprising a configuration in which a plurality of non-aqueous secondary batteries are layered, the plurality of non-aqueous secondary batteries each comprising:
a positive-electrode collector layer;
a positive-electrode layer formed on one surface of the positive-electrode collector layer;
a negative-electrode collector layer;
a negative-electrode layer formed on one surface of the negative-electrode collector layer so as to be opposed to the positive-electrode layer;
a separator containing an electrolytic solution provided between the positive-electrode layer and the negative-electrode layer;
a positive-electrode-side insulating layer formed on another surface of the positive-electrode collector layer;
a negative-electrode-side insulating layer formed on another surface of the negative-electrode collector layer; and
a sealing agent comprising a multilayer structure including at least a positive-electrode fusion layer, a gas barrier layer, and a negative-electrode fusion layer, the sealing agent being provided on an inner surface of a peripheral edge of the positive-electrode collector layer and an inner surface of a peripheral edge of the negative-electrode collector layer so as to surround the positive-electrode layer and the negative-electrode layer,
wherein adjacent ones of the plurality of non-aqueous secondary batteries share the positive-electrode-side insulating layer and/or the negative-electrode-side insulating layer.

2. A non-aqueous secondary battery layered structure according to claim 1, wherein the adjacent ones of the plurality of non-aqueous secondary batteries comprise a configuration in which the positive-electrode collector layers or the negative-electrode collector layers are opposed to each other with the shared positive-electrode-side insulating layer or the shared negative-electrode-side insulating layer interposed therebetween.

3. A non-aqueous secondary battery layered structure according to claim 1,
wherein the adjacent ones of the plurality of non-aqueous secondary batteries further share the positive-electrode collector layer and/or the negative-electrode collector layer in contact with the shared positive-electrode-side insulating layer or the shared negative-electrode-side insulating layer,
wherein the shared positive-electrode-side insulating layer and/or the shared negative-electrode-side insulating layer have an opening, and
wherein the positive-electrode layer or the negative-electrode layer of one of the adjacent ones of the plurality of non-aqueous secondary batteries is buried in the opening.

4. A non-aqueous secondary battery layered structure according to claim 3, wherein the shared positive-electrode collector layer and/or the shared negative-electrode collector layer has a through-hole in a contact surface with respect to the positive-electrode layer and/or the negative-electrode layer.

5. A non-aqueous secondary battery layered structure according to claim 3, wherein the shared positive-electrode collector layer and/or the shared negative-electrode collector layer comprises a mesh-shaped contact surface with respect to the positive-electrode layer and/or the negative-electrode layer.

6. A non-aqueous secondary battery layered structure according to claim 4,
wherein the adjacent ones of the plurality of non-aqueous secondary batteries further share the negative-electrode collector layer in contact with the shared positive-electrode-side insulating layer or the shared negative-electrode-side insulating layer,
wherein the negative-electrode collector layer comprises a mesh-shaped contact surface with respect to the negative-electrode layer, and
wherein the negative-electrode layer contains lithium as a negative-electrode active material.

7. A non-aqueous secondary battery layered structure according to claim 1, wherein the positive-electrode collector layer contains aluminum as a main component, and the negative-electrode collector layer contains copper as a main component.

8. A non-aqueous secondary battery layered structure according to claim 1, wherein the positive-electrode collector layer has a thickness of 12 μm or more and 68 μm or less.

9. A non-aqueous secondary battery layered structure according to claim 1, wherein the positive-electrode layer contains a nitroxyl radical polymer.

10. A non-aqueous secondary battery layered structure according to claim 1, wherein the separator is interposed in the sealing agent.

11. A non-aqueous secondary battery layered structure according to claim 10,
wherein the positive-electrode layer has a thickness larger than a thickness of the negative-electrode layer, and
wherein the separator is interposed between the gas barrier layer and the negative-electrode fusion layer.

12. A non-aqueous secondary battery layering method, comprising layering a plurality of non-aqueous secondary batteries so that adjacent ones of the plurality of non-aqueous secondary batteries share a positive-electrode-side insulating layer and/or a negative-electrode-side insulating layer,
the plurality of non-aqueous secondary batteries each comprising:
a positive-electrode collector layer;
a positive-electrode layer formed on one surface of the positive-electrode collector layer;
a negative-electrode collector layer;
a negative-electrode layer formed on one surface of the negative-electrode collector layer so as to be opposed to the positive-electrode layer;
a separator containing an electrolytic solution provided between the positive-electrode layer and the negative-electrode layer;
a positive-electrode-side insulating layer formed on another surface of the positive-electrode collector layer;
a negative-electrode-side insulating layer formed on another surface of the negative-electrode collector layer; and
a sealing agent comprising a multilayer structure including at least a positive-electrode fusion layer, a gas barrier layer, and a negative-electrode fusion layer, the sealing agent being provided on an inner surface of a peripheral edge of the positive-electrode collector layer and an inner surface of a peripheral edge of the negative-electrode collector layer so as to surround the positive-electrode layer and the negative-electrode layer.
